(19) United States
(12) Patent Application Publication
(10) Pub. No.: US 2016/0293181 A1
(43) Pub. Date: Oct. 6, 2016

(54) MECHANISM FOR FACILITATING WATERMARKING-BASED MANAGEMENT OF ECHOES FOR CONTENT TRANSMISSION AT COMMUNICATION DEVICES.

(71) Applicant: INTEL CORPORATION, Santa Clara, CA (US)

(72) Inventors: ADRIEN DANIEL, Antibes, 06 (FR); LUDOVICK LEPAULOUX, Cannes (FR)

(21) Appl. No.: 15/036,774

(22) PCT Filed: Jan. 17, 2014
(86) PCT No.: PCT/US2014/012119

§ 371 Date: May 13, 2016

(51) Int. Cl. G10L 21/0364; G10L 19/018; G10L 21/0232; H04M 1/20

(52) U.S. Cl. CPC G10L 21/0364; H04M 1/20; G10L 19/018; G10L 21/0232; G10L 2021/02082

(57) ABSTRACT

A mechanism is described for facilitating echo watermarking and filtering at computing devices according to one embodiment. A method of embodiments, as described herein, includes assigning a watermark to a communication signal, where the watermarked communication signal transforms into a watermarked echo upon exiting a computing device. The method may further include receiving the watermarked echo, filtering the watermarked echo such that the watermarked echo is cancelled out of a final signal, and transmitting the final signal that is free of the watermarked echo.

### FIELD

Embodiments described herein generally relate to computers. More particularly, embodiments relate to a mechanism for facilitating watermarking-based management of echoes for content transmission at communication devices.

### BACKGROUND

Echoes can be very disturbing and are often regarded as the worst type of impairment during conversations. Although various conventional echo cancellation techniques are employed at today's communication devices, these conventional techniques are inefficient as they are not known for complete elimination of echoes.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates an echo watermarking and filtering mechanism at a computing device according to one embodiment.

FIG. 2 illustrates an echo watermarking and filtering mechanism according to one embodiment.

FIG. 3A illustrates a computing device having various components of an echo watermarking and filtering mechanism of FIG. 2 according to one embodiment.

FIG. 3B illustrates a computing device having a watermark echo cancellation engine and a gain watermark echo cancellation engine of an echo watermarking and filtering mechanism of FIG. 2 according to one embodiment.

FIG. 4 illustrates computer system suitable for implementing embodiments of the present disclosure according to one embodiment.

FIG. 5 illustrates a method for facilitating watermarking and filtering of echoes at a computing device according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for extraction and/or suppression of communication signals (e.g., audio signal) that are classified as echoes (also referred to as “echo signals”) from a mixture of signals based on watermarking of the audio signals, where the mixture of signals being communicated between computing/communication devices (e.g., smartphones, table computers, etc.) over a network. In one embodiment, an audio signal, regarded as an echo, is watermarked prior to exiting the communication device so it may be recognized as the echo and sufficiently suppressed upon re-entering the communication device. For example, watermarking may be assigned according to a binary representation by using two different echo kernels (e.g., “one” kernel and “zero” kernel) to convolve the carrier audio signal. The two kernels may differ in the delay of the inserted echo and accordingly, at decoding, the bit value of each timeframe is recovered by comparing the presence of echo at the two expected delay values in the watermarked signal. Having taken into various account human ear capabilities and features, this novel and innovative technique of watermarking by echo-hiding may remain transparent to the human ear.

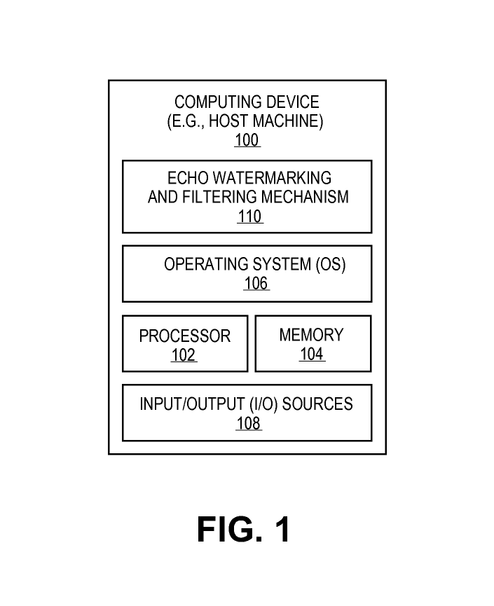

FIG. 1 illustrates an echo watermarking and filtering mechanism 110 at a computing device 100 according to one embodiment. Computing device 100 serves as a host machine for hosting echo watermarking and filtering mechanism (“echo mechanism”) 110 that includes a combination of any number and type of components for facilitating watermarking and hiding of echoes within transmission voices over communication devices, such as computing device 100.

Computing device 100 may include any number and type of communication devices, such as large computing systems, such as server computers, desktop computers, etc., and may further include set-top boxes (e.g., Internet-based cable television set-top boxes, etc.), global positioning system (GPS)-based devices, etc. Computing device 100 may include mobile computing devices serving as communication devices, such as cellular phones including smartphones (e.g., iPhone® by Apple®, BlackBerry® by Research in Motion®, etc.), personal digital assistants (PDAs), tablet computers (e.g., iPad® by Apple®, Galaxy 3® by Samsung®, etc.), laptop computers (e.g., notebook, netbook, an Ultrabook™ system, etc.), e-readers (e.g., Kindle® by Amazon®, Nook® by Barnes and Nobles®, etc.), smart televisions, wearable devices (e.g., watch, bracelet, smartcard, etc.), media players, etc.

Computing device 100 may include an operating system (OS) 106 serving as an interface between hardware and/or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc. It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, and “software package” may be used interchangeably throughout this document. Similarly, terms like “job”, “input”, “request” and “message” may be used interchangeably throughout this document.

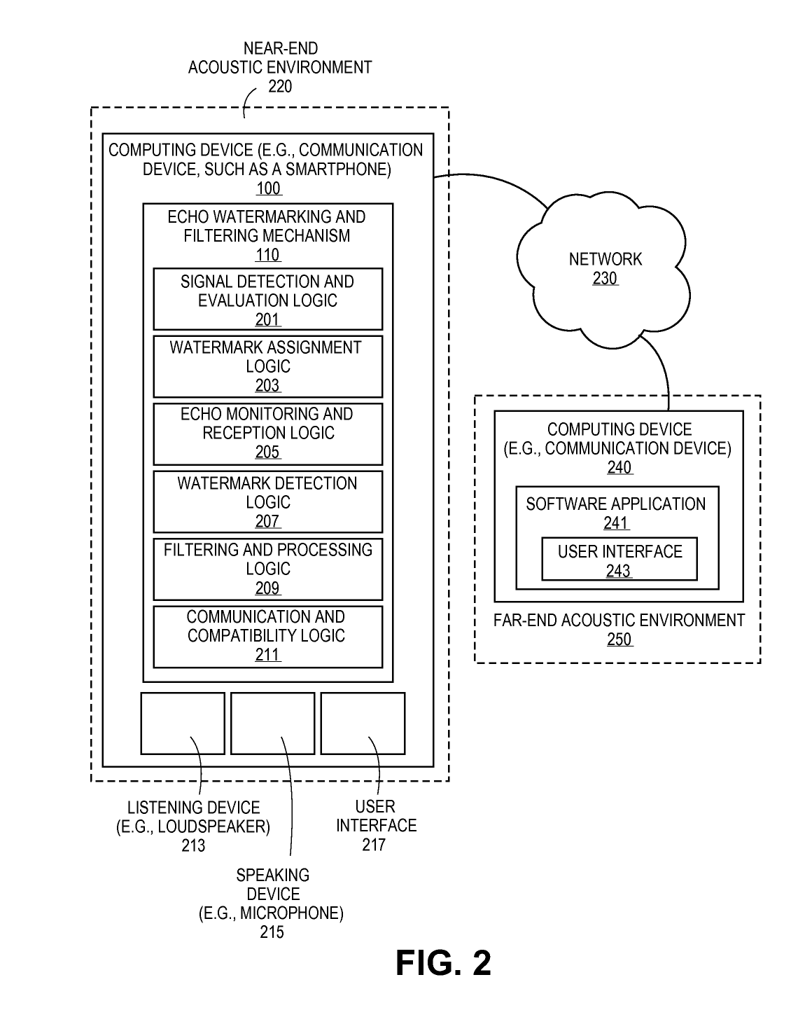

FIG. 2 illustrates an echo watermarking and filtering mechanism 110 according to one embodiment. In one embodiment, echo mechanism 110 may be employed at computing device 100 serving as a communication device, such as a smartphone, a wearable device, a tablet computer, a laptop computer, a desktop computer, etc. In one embodiment, echo mechanism 110 may include any number and type of components, such as: signal detection and evaluation logic 201, watermark assignment logic 203, echo monitoring and reception logic 205, watermark detection logic 207, filtering and processing logic 209, and communication/compatibility logic 211.

In some embodiments, computing device 100 may contain any number and type of other components to working with echo mechanism 110 to perform various conventional and non-conventional tasks. Many of such components are not discussed here and may include (but not limited to) equalizer dynamic control (EDC), speech intelligibility enhancement (SIE), signal and noise estimation (SNE), acoustic echo cancellation (AEC), gain loss control (GLC), noise reduction component including residual echo suppression component, or the like.

A communication signal (such as an audio signal (e.g., telephone voice signal, etc.), an audio/video signal (e.g., FaceTime® communication signal, Tango® communication signal, etc.), or the like) may be communicated between computing device 240 within far-end acoustic environment 220 and computing device 100 within near-end acoustic environment 250 over one or more communication networks, such as network 230 (e.g., telecommunication network, Internet, cloud network, etc.). It is contemplated that the communication between computing devices 100, 240 may be facilitated via one or more communication software applications, such as software application 241, provided by one or more telecommunication companies (e.g., Skype®, FaceTime® by Apple®, Tango®, Viber®, AT&T®, Verizon®, etc.). It is contemplated that one or more user interfaces, such as user interfaces 217, 243, provided by software applications, such as software application 242, may be used at computing devices 100, 240, to facilitate communication of signals (such as regular telephone calls, FaceTime® calls, etc.).

It is contemplated that although the illustrated embodiment provides for having echo mechanism 110 employed at computing device 100 serving as a near device where a communication signal is received from computing device 240, serving as a far device, for echo processing and filtering purposes, embodiments are not limited to this particular arrangement and that the tasks may be reversed between computing devices 110 and 240 and that any number and type of other computing devices (without or without echo mechanism 110) may be included in the fold along with any number and type of networks.

Once the communication signal (or simply “signal”) is received at computing device 100, it is to be passed and sounded through a listening device, such as listening device 213 (e.g., loudspeaker, etc.), at computing device 100 and which may then expected to create an echo once it has left listening device 213 and received at or fed back into a speaking device, such as speaking device 215 (e.g., microphone). In one embodiment, upon receiving the communication signal at computing device 100, it may then be detected and evaluated by signal detection and evaluation logic 201 to be considered as a potential echo. For example, as the communication signal is received at computing device 100 and going through typical communication components towards listening device 213, it may be detected by signal detection and evaluation logic 201 prior to reaching listening device 213 so that it may then be evaluated for possible watermarking prior to being mixed with other exterior signals, such as the voice of the user of computing device 100 at the receiving end and any other noise (e.g., traffic, crowd, television, etc.) that may be part of near-end acoustic environment 220.

In one embodiment, upon detection of the signal and the subsequent evaluation that it is regarded to be an echo, watermark assignment logic 203 assigns the signal a watermark for future recognition when it is returned to computing device 100 as an echo via speaking device 215. In one embodiment, echo monitoring and reception logic 205 continuously monitors the watermarked echo as it leaves listening device 213 and travels through the air and reaches speaking device 215 where it is received by echo monitoring and reception logic 205. It is contemplated the watermarked echo may not be the only sound received at speaking device 215 and that any number and types of other sounds may also be received and converged into becoming a mixture signal, including (but not limited to) human voice of a first user of computing device 100 and other noises and sounds, such as other human voices, traffic, etc., that may fall within near-end acoustic environment 220 and the reach of speaking device 215.

Upon receiving the watermarked echo at speaking device 215, the watermarked echo is detected by watermark detection logic 207 to be the echo as opposed to other noises and sounds that are entered through speaking device 215. In one embodiment, the detected watermarked echo is then processed to be dynamically filtered by filter and processing logic 209. For example, in some embodiments, the watermarked echo may be completely suppressed (also referred to as “cancelled”, “eliminated”, “removed”, or “hidden”); while, in some embodiments, the watermarked echo may be partially suppressed from reaching a second user of computing device 240, such as certain portions (e.g., certain words, frequency segments, etc.) may be eliminated or not eliminated and allowed to pass. For example, certain frequency segments may not be audible to the human ear and thus, there may not be a need to watermarked or eliminate them. In yet other embodiments, the watermarked echo may not be suppressed at all and allowed to pass on to computing device 240 over network 230, while, in yet other embodiments, only the watermarked echo may be kept and allowed to pass, while all other noises and sounds may be suppressed, such as when the watermarked echo is being used for detective purposes or in security situations, such as in police detective work, military work, etc.

In one embodiment, the signal may be broken down into segments and the segments may be selectively watermarked by watermark assignment logic 203, where each segment may represent or include a frequency band. For example, in some embodiments, the watermark may not be applied to the entire spectrum of the signal and that it may be applied selectively to any number and type of segments depending on the frequencies they represent. Accordingly, when the watermarked echo is detected by watermark detection logic 207, this allows for subsequent echo estimation at bands or sub-bands rather than on the entire signal or the mixture of sounds, which allows for filtering and processing logic 209 to perform frequency responses varying in time.

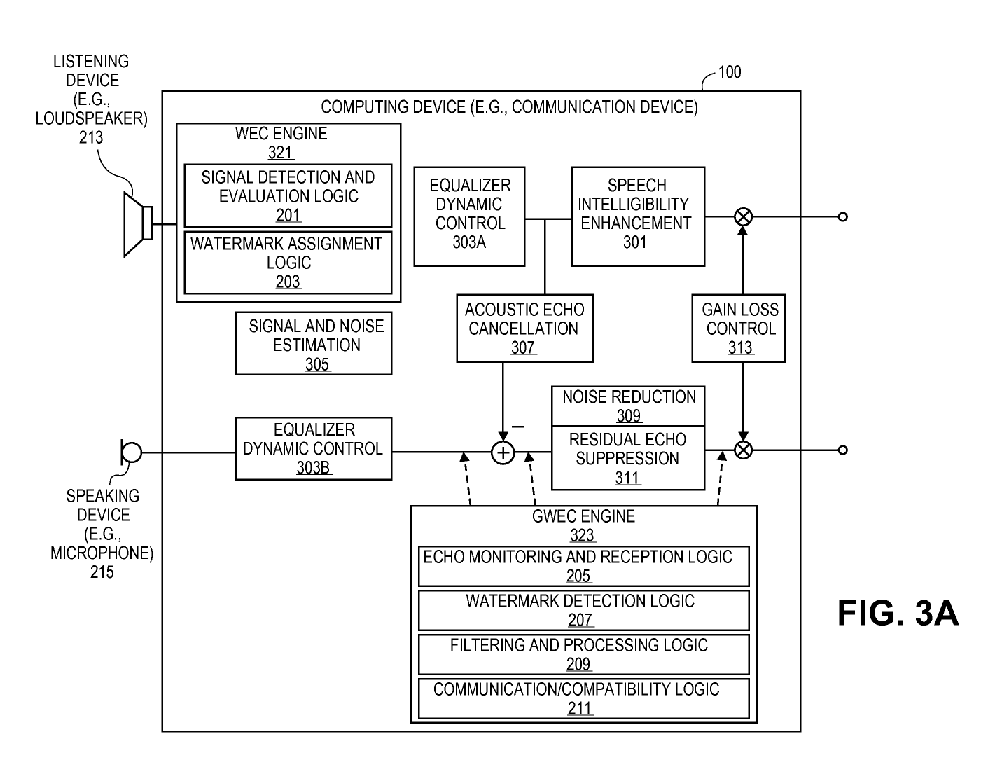

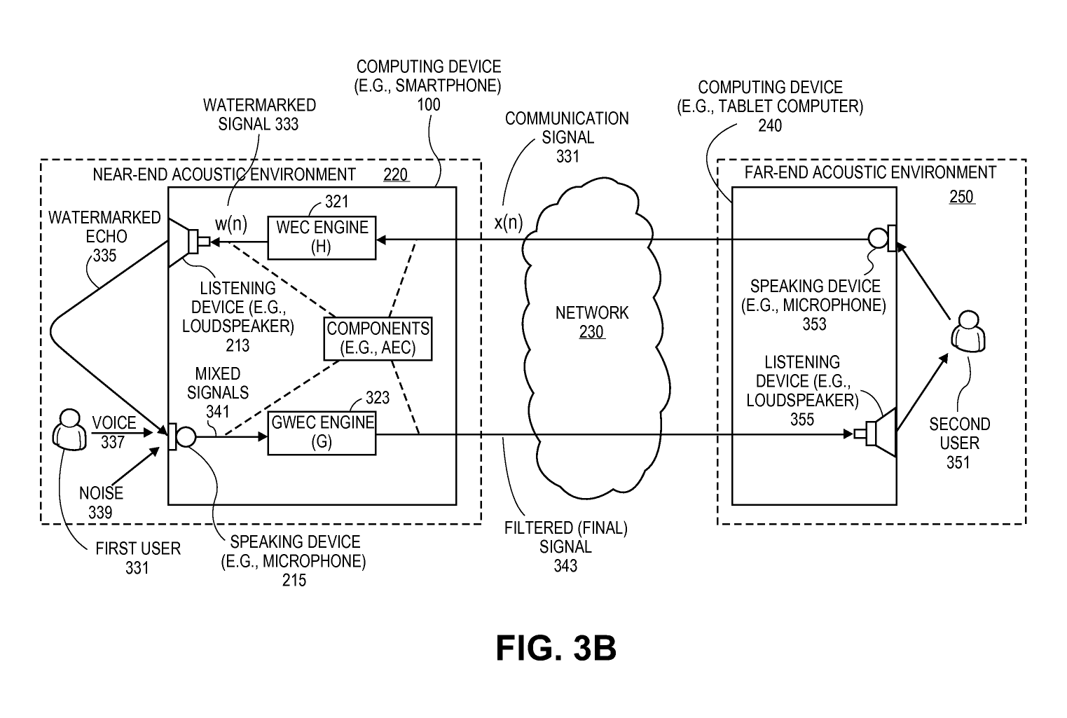

In one embodiment, the communication signal includes a loudspeaker signal that is obtained and decoded form network 230 which is to be sent to listening device 213. As aforementioned, the mixture signal, entering through speaking device 215, may include a sum of (but not limited to): (i) the echo, such as the loudspeaker signal after playback (ii) the environmental noise of near-end acoustic environment 220, and (iii) the useful speech from near-end speaker, such as first user. As will be further described with reference to FIGS. 3A-3b, it is contemplated that echo mechanism 110 may be employed with other techniques, such as having adaptive echo canceller (AEC) that may use the loudspeaker signal as a reference signal of the echo signal that is picked-up by speaking device 215.

Echo Kernel

As aforementioned, watermark assignment logic 203 may be used to track segments (e.g., frequency brands) of the communication signal may be watermarked after being tracked and detected by signal detection and evaluation logic 201. For example, an “echo kernel” may refer to an expression of a delay line as a linear filter, while a “sub-band echo kernel” (“sub-band kernel” or simply “sub-kernel”) may refer to a subset of contiguous frequency bins of a band echo kernel, and a “full-band echo kernel” (“full-band kernel” or simply “full kernel”) may be an echo kernel. For example, a sub-kernel may be derived from an echo kernel which may have been shifted, scaled, and enforced to have a real valued impulse response.

In one embodiment, sub-kernels equivalent to a full kernel may be derived, where the targeted echo kernel includes a set of independent sub-kernels. For example, a different kernel may be used in each sub-kernel, while choosing and using a single type of kernel for all sub-kernels ensures that the resulting full kernel is equivalent to the echo kernel.

In one embodiment, let us suppose an echo refers to a feed-forward comb filter, of which unit sample response is as follows:

$$h ( n ) = {\sum }_{n = - ∞}^{∞} δ ( n ) + a δ ( n - D ) ,$$

where α is the scaling factor (e.g., the amplitude of the echo), and D is the echo delay in samples. In one embodiment, let us suppose that α<1 and D>0. For instance, the coefficients of a 50% echo of 4 samples (e.g., α=0.5 and D=4) are:

h=[1 0 0 0.5].

As mentioned, for example, the set of sub-kernels be equivalent to a full kernel to ensure acceptable distortions in the watermarked signal. Further, essentials for latter detection of the watermark are to constrain the sub-kernels to have an echo kernel form as well. An echo kernel may have the following frequency response:

H(ω)=1+αe^{-jωD}=1+α cos(ωD)−jα sin(ωD).

Within each interval [kπ; (k+1)π], kε [symbol] , H is periodic of period

$$\frac{2 π}{D} .$$

Let us consider a frequency-shifted version of H to be as follows:

$$H ( ω + k \frac{π}{K} ) ,$$

where K is the desired number of bands, and k−0 . . . K−1. If one chooses K=D/2q, where integer q is the number of periods per band:

$$\begin{matrix}H ( ω + k \frac{π}{K} ) = H ( ω + k 2 q \frac{π}{D} ) \\ = H ( ω )\end{matrix}$$

because H is

$$\frac{2 π}{D}$$

periodic within [0; π]

The filter is then frequency scaled by factor

$$\frac{1}{K} \text{:}$$

$$H ( \frac{ω + k \frac{π}{K}}{K} ) = H ( \frac{ω}{K} ) .$$

This frequency response is truncated over [0; π]:

$$\begin{matrix}{{H}^{′}}_{[ 0 \text{:} n ]} ( ω ) = H ( \frac{ω + k \frac{π}{K}}{K} ) {1}_{[ 0 \text{:} n ]} \\ = H ( \frac{ω}{K} ) {1}_{[ 0 \text{:} n ]} .\end{matrix}$$

From this truncated frequency response, a sub-band filter H′ may be defined by assuming that its time-domain coefficients are real, which may be imposed by wanting of the sub-band filter to be of the echo kernel form. We chose K=D/2q:

$$H ( \begin{matrix}ω \\ K\end{matrix} ) = 1 \vert α {e}^{- 1 \frac{ω}{K} D} = 1 \vert α {e}^{- 2 q j ω} ,$$

which is periodic of period

$$\frac{π}{q} .$$

Accordingly, interval [0; π] spans a whole number q of periods of H

$$( \frac{ω}{K} ) .$$

Consequently, the frequency response of sub-band filter H′ is periodic and equal to that of H

$$( \frac{ω}{K} ) \text{:}$$

$${H}^{′ ( ω )} = H ( \frac{ω}{K} ) \\ = 1 \vert α {e}^{- j \frac{ω}{K} D} \\ = 1 + α {e}^{- j ω \frac{D}{K}} \\ = 1 + α {e}^{- j ω {D}^{′}} .$$

From this point of view, H′ is a sub-kernel with delay

$${D}^{′} = \frac{D}{K} = \frac{D}{D \text{/} 2 q} = 2 q samples ,$$

derived from the full-kernel H.

Communication Signal Watermarking

As will be further described with respect to FIG. 3A-3C, an input communication signal x(n), may be watermarked, via watermark assignment logic 203, by convolution with the full kernel H to obtain signal w(n). In the context of acoustic echo cancellation, the signal x(n) may stand for the signal coming over network 230 and being played by listening device 213.

Detecting Presence of Watermarked Echo Upon Passing Speaking Device 215

The detection of the watermark in the microphone signal may be based on the cepstral analysis, [See Gruhl et al., Echo Hiding, 1996], except that, in one embodiment, it may be performed in sub-kernels (as opposed to on an entire broadband communication signal) and further, the watermarked signal may be detected from a mixture of signals, such as noise and sounds of near-end acoustic environment 220, containing the watermarked signal.

Echo Detection

Computation of the cepstrum of the watermarked signal W(n) may allow for the separation of the echo kernel H from the original signal X(n) it has been convolved with as follows:

$$w ( n ) = x ( n ) * h ( n )$$

$$W ( ω ) = X ( ω ) H ( ω )$$

$$\tilde{w} ( n ) = {ℱ}^{- 1} log [ W ( ω ) ] \\ = {ℱ}^{- 1} log [ X ( ω ) H ( ω ) ] \\ = {ℱ}^{- 1} [ log X ( ω ) + log H ( ω ) ] \\ = {ℱ}^{- 1} \vert log X ( ω ) \vert + {ℱ}^{- 1} \vert log H ( ω ) \vert \\ = \tilde{x} ( n ) + h ( n ) ,$$

where \tilde{w}, \tilde{x} and \tilde{h} refer to the complex cepstra of w, x and h, respectively. For example, cepstral analysis converts the convolution operation to an addition operation. Regarding the cepstrum of h:

$$\tilde{h} ( n ) = {ℱ}^{- 1} log [ H ( ω ) ] \\ - {ℱ}^{- 1} log [ \vert H ( ω ) \vert {e}^{j arg H ( ω )} ] \\ = {ℱ}^{- 1} [ log \vert H ( ω ) \vert + log {e}^{j arg H ( ω )} ] \\ - {ℱ}^{- 1} [ log \vert H ( ω ) \vert + j arg H ( ω ) ] \\ = {ℱ}^{- 1} log \vert H ( ω ) \vert + {ℱ}^{- 1} \vert j arg H ( ω ) \vert \\ = {ℱ}^{- 1} log \vert H ( ω ) \vert + {ℱ}^{- 1} [ j log H ( ω ) ] .$$

The two terms in the inverse Fourier transforms:

$$log \vert H ( ω ) \vert = log \sqrt{{( 1 + α )}^{2} + 2 α cos ( ω D )} - \frac{1}{2} log [ {( 1 + α )}^{2} + 2 α cos ( ω D ) ]$$

$$and$$

$$j log H ( ω ) = j log [ 1 + α {e}^{- j ω D} ]$$

are both periodic of period

$$\frac{2 π}{D} .$$

Therefore, according to the Fourier analysis, their inverse Fourier transforms show in \tilde{h}(n) one strong component at its fundamental frequency n=D. A first option to detect if an echo of delay D is present in \tilde{w} is may be to look at value \tilde{w}(D).

However, because of the presence of the log function in both terms, additional components may show as well in \tilde{h}(n) at its harmonic frequencies n=2D, 3D, etc. Accordingly, to further improve the detection of an echo of delay D in \tilde{w}, the autocorrelation R_{\tilde{w}\tilde{w}}(n) of \tilde{w} is usually computed to obtain the power of the signal found at each delay n. For example, one can decide on the presence of an echo of delay D by looking at whether a power spike is present at value R_{\tilde{w}\tilde{w}}(D).

One Embodiment of an Implementation of Echo Detector in Sub-Band Echoes

In one embodiment, the frequency analysis of the microphone signal y(n) may be performed based on a Short-Term Fourier Transform (STFT), such as:

Y(l,m)=w(l,m)+S(l,m)+Z(l,m),

where W is the watermarked loudspeaker signal, S is the near-end speech signal (useful speech, such as by the first user of computing device 100), Z is the environmental noise signal, such as from near-end acoustic environment 220, l is the frequency bin, and m is the temporal frame index.

Following the aforementioned sub-band kernel watermarking approach, for each temporal frame m, Y is decomposed in

$$K = \frac{D}{2 q}$$

sub-band signals

Yₖ=Y[k2q_{D}^{π} . . . (k|1)2q_{D}^{π}], k=0 . . . K−1 (index m is omitted for clarity):

$${Y}_{0} = Y [ 0 … 2 q \frac{π}{D} ] , \\ {Y}_{1} = Y [ q \frac{π}{D} … 4 q \frac{π}{D} ] , \\ ⋮$$

$${Y}_{K - 1} = Y [ π - 2 q \frac{π}{D} … π ] .$$

A frequency shifting by

$$k 2 q \frac{π}{D}$$

followed by a frequency scaling of

$$\frac{1}{K}$$

is applied to each Y_k, to obtain Yₖ′. Therefore, in this particular case for which Y−W, signals Yₖ′ are equal to the product of Xₖ′ with H′, such as xₖ′ convolved with the sub-kernel h′ of delay D′=2q.

For each temporal frame, for example, a Discrete Fourier Transform (DFT) may be performed on N points. Based on the previous remarks, the N/2+1 useful frequency bins may be grouped in K bands of an equal number of frequency bins

$$M = \frac{N \text{/} 2 + 1}{K} .$$

Filter Based on Watermarking Presence

For one temporal frame (omitting index m):

Yₖ(l)=Wₖ(l)+Sₖ(l)+Zₖ(l), with Wₖ′(l)=Xₖ′(l)Hₖ′(l).

Cepstrum of yₖ′ then equals:

$${\tilde{y}}_{k}^{′} ( n ) = {ℱ}^{- 1} log {Y}_{k}^{′} ( l ) \\ = {ℱ}^{- 1} log [ {W}_{k}^{′} ( l ) + {S}_{k}^{′} ( l ) + {Z}_{k}^{′} ( l ) ]$$

When Wₖ′(l)>>Sₖ′(l)+Zₖ′(l), then:

$${\tilde{y}}_{k}^{′} ( n ) \approx {ℱ}^{- 1} log {W}_{k}^{′} ( l ) \\ \approx {\tilde{w}}_{k}^{′} ( n ) \\ \approx {\tilde{x}}_{k}^{′} ( n ) + {\tilde{h}}_{k}^{′} ( n )$$

Due to the presence of the echo kernel \tilde{h}ₖ′ of delay D′, R_{\tilde{y}}_{ₖ}_{′\tilde{y}}_{ₖ}_{′}(D′) may have a high value.

On the opposite, when Wₖ′(l)<<Sₖ′(l)+Zₖ′(l), then:

\tilde{y}ₖ′(n)≈τ⁻¹ log [Sₖ′(l)+Zₖ′(l)]

and assuming that Sₖ′+Zₖ′ does not result from the convolution with an echo kernel of delay D′, R_{\tilde{y}}_{ₖ}_{′\tilde{y}}_{ₖ}_{′}(D′) will not have a high value.

In the following, let us suppose that the desired behavior is to remove signal Wₖ′ from Yₖ′, but a similar reasoning can be used to keep Wₖ′ only. A simple, binary gain rule consists in setting a threshold τ above which Yₖ′ is considered as being mainly composed of Wₖ′.

$$G ( k ) = \{ \begin{matrix}{g}_{min} , & for {R}_{{\tilde{y}}_{k}^{′} {\tilde{y}}_{k}^{′}} ( {D}^{′} ) \geq τ \\ {g}_{max} , & otherwise\end{matrix}$$

For instance, setting gₘᵢₙ=0 and gₘₐₓ=1 results in a filter which removes bands mainly composed of watermarked signal while keeping other bands.

By extension, one can define a smoother gain rule based on two thresholds τₘᵢₙ and τₘₐₓ:

$$G ( k ) - ( 1 - \frac{{R}_{τ} {τ}_{min}}{{τ}_{max} - {τ}_{min}} ) ( {g}_{max} - {g}_{min} ) + {g}_{min}$$

$$with$$

$${R}_{T} = max ( min ( {R}_{{\tilde{y}}_{k}^{′} {\tilde{y}}_{k}^{′}} ( {D}^{′} ) , {τ}_{max} ) , {τ}_{min} )$$

This gain rule verifies that for R_{ý}_{ₖ}_{′ý}_{ₖ}_{′}(D′)≧τₘₐₓ, G(k)=gₘᵢₙ, and that for R_{ý}_{ₖ}_{′ý}_{ₖ}_{′}(D′)<τₘᵢₙ, Gₖ(l)=gₘₐₓ. For values of R_{ý}_{ₖ}_{′ý}_{ₖ}_{′}(D′) between τₘᵢₙ and τₘₐₓ, G(k) is inversely proportional to R_{ý}_{ₖ}_{′ý}_{ₖ}_{′}(D′).

Filtering of Watermarked Echo Received Via Speaking Device 215

With regard to filtering of watermarked echo (e.g., “microphone signal”) that is received via speaking device 215, any filtering method (e.g., Inverse Discrete Fourier Transform (IDFT), Overlap-Add (OLA), Analysis-Synthesis Filter-Bank (ASFB), Filter-Bank Equalizer (FBE), Low Delay Filter (LDF), etc.) may be used to apply the gain rule defined in the analysis stage as described above. For example, the hop size used for the STFT at analysis may be chosen to match that of the filtering method. Also, because analysis may need rather long frames to be efficient, the frames used at the filtering stage may be centered on that used for analysis.

Computing devices 100, 240 may further include any number and type of touch/image components, where these touch/image components may include (but not limited to) image capturing devices (e.g., one or more cameras, etc.) and image sensing devices, such as (but not limited to) context-aware sensors (e.g., temperature sensors, facial expression and feature measurement sensors, etc.) working with one or more cameras, environment sensors (such as to sense background colors, lights, etc.), biometric sensors (such as to detect fingerprints, facial points or features, etc.), and the like. Computing devices 100, 240 may also include one or more software applications, such as business applications, social network websites (e.g., Facebook®, Google+®, Twitter®, etc.), business networking websites (e.g., LinkedIn®, etc.), communication applications (e.g., Skype®, Tango®, Viber®, etc.), games and other entertainment applications, etc., offering one or more user interfaces (e.g., web user interface (WUI), graphical user interface (GUI), touchscreen, etc.), while ensuring compatibility with changing technologies, parameters, protocols, standards, etc.

Communication/compatibility logic 211 may be used to facilitate dynamic communication and compatibility between computing device 100 and any number and type of other computing devices (such as a mobile computing device, a desktop computer, a server computing device, etc.), storage devices, databases and/or data sources (such as data storage devices, hard drives, solid-state drives, hard disks, memory cards or devices, memory circuits, etc.), networks (e.g., cloud network, the Internet, intranet, cellular network, proximity networks, such as Bluetooth, Bluetooth low energy (BLE), Bluetooth Smart, Wi-Fi proximity, Radio Frequency Identification (RFID), Near Field Communication (NFC), Body Area Network (BAN), etc.), wireless or wired communications and relevant protocols (e.g., Wi-Fi®, WiMAX, Ethernet, etc.), connectivity and location management techniques, software applications/websites, (e.g., social and/or business networking websites, such as Facebook®, LinkedIn®, Google+®, Twitter®, etc., business applications, games and other entertainment applications, etc.), programming languages, etc., while ensuring compatibility with changing technologies, parameters, protocols, standards, etc.

Although one or more terms or examples (e.g., communication signals, loudspeaker signals, microphone signals, watermarked signals, echoes, echo kernels, sub-kernels, full-kernels, segments including frequency bands, telephones, smartphones, table computers, etc.) may be discussed throughout this document for brevity, clarity, and ease of understanding, it is contemplated that embodiments are not limited to any particular number and type of gestures, display panels, computing devices, users, network or authentication protocols or processes, or the like. For example, embodiments are not limited to any particular network security infrastructures or protocols (e.g., single-sign-on (SSO) infrastructures and protocols) and may be compatible with any number and type of network security infrastructures and protocols, such as security assertion markup language (SAML), OAuth, Kerberos, etc.

Throughout this document, terms like “logic”, “component”, “module”, “framework”, “engine”, “point”, and the like, may be referenced interchangeably and include, by way of example, software, hardware, and/or any combination of software and hardware, such as firmware. Further, any use of a particular brand, word, term, phrase, name, and/or acronym, such as “echo cancellation” or “EC”, “watermark echo cancellation” or “WEC”, “gain watermark echo cancellation” or “GWEC”, “watermark echo filtering” or “WEF”, “communication signal”, “loudspeaker signal”, “microphone signal”, “watermark” or “watermarking”, “watermarked signal”, “echo” or “watermarked echo”, “echo kernel”, “sub-band echo kernel” or “sub-kernel”, “full-band echo kernel” or “full kernel”, “segment” or “frequency band”, “telephone”, “smartphone”, “tablet computer”, etc., should not be read to limit embodiments to software or devices that carry that label in products or in literature external to this document.

It is contemplated that any number and type of components may be added to and/or removed from echo watermarking and filtering mechanism 110 to facilitate various embodiments including adding, removing, and/or enhancing certain features. For brevity, clarity, and ease of understanding of echo watermarking and filtering mechanism 110 and flexible wraparound display 120, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

FIG. 3A illustrates a computing device 100 having various components of echo watermarking and filtering mechanism 110 of FIG. 2 according to one embodiment. For brevity, clarity, and ease of understanding, many of the components and processes already described with reference to FIGS. 1-2 may not be described here. In the illustrated embodiment, a communication signal is received at computing device 100 and passes through speech intelligibility enhancement 301 and equalizer dynamic control 303A and further through watermark echo cancellation (WEC) engine 321 having signal detection and evaluation logic 201 and watermark assignment logic 203 to perform their respective tasks before the watermarked signal is passed through listening device (e.g., loudspeaker, etc.) 213. As aforementioned, in one embodiment, any number and type of segments of the signal may be watermarked as opposed to watermarking the entire signal. Each segment represents a frequency band.

Upon entering the air, the watermarked signal turns into a watermarked echo (e.g., watermarked segments or bands, such as full band echoes, sub-band echoes, etc.) which may then be returned and fed back into computing device 100 via speaking device 215 (e.g., microphone, etc.) as part of a mixture of signals including (but not limited to) useful sound (e.g., user's voice), other noises/sounds (e.g., kids, market noises, traffic sounds, office chatter, background television sound, etc.) within the acoustic environment of computing device 100. The watermarked echo is monitored and then received at speaking device 215 as a mixture of voice, noise, and watermarked echo. The monitoring and receiving is performed by echo monitoring and reception logic 205 of gain watermark echo cancellation (GWEC) engine 323.

In one embodiment, additional components, such as equalizer dynamic control 303B, signal and noise estimation 305, acoustic echo cancellation 307, noise reduction 309, residual echo suppression 311, and gain loss control 313 may also be employed to perform their respective tasks. In another embodiment, components 301, 303A-B, 305, 307, 309, 311, 313 may not be needed and instead, they be replaced by other components or simply WEC 312 and GWEC 323 of echo mechanism 110. It is contemplated that components 301, 303A-B, 305, 307, 309, 311, 313 and their corresponding connections, paths, and tasks are merely shown and/or discussed as examples for brevity, clarity, and ease of understanding and that embodiments are not limited to any of these or other such components. For example, GWEC 323 may be placed or allowed to function before or after noise reduction 309 and similarly, before or after acoustic echo cancellation 307, etc.

In one embodiment, GWEC having echo monitoring and reception logic 205, watermark detection logic 207, filtering and processing logic 209, and communication/compatibility logic 211 perform any number of tasks as described with reference to FIG. 2, such as to detect, the watermarked echo from the mix of signals using watermark detection logic 207, and process detected watermarked echo such that it completely cancelled (e.g., all segments of the watermark echo are suppressed), partially filtered (e.g., some segments are suppressed and others are allowed to pass), the entire echo remains unfiltered and is allowed to pass, or the like. Communication/compatibility logic 211 manages compatibility of echo mechanism 110 with other components, such as components 301, 303A-B, 305, 307, 309, 311, 313, and computing devices, etc., and manages the movement, communication, and/or cancellation of one or more of the watermark echo and other signals of the mix as determined by GWEC engine 323.

FIG. 3B illustrates a computing device 100 having watermark echo cancellation engine 321 and gain watermark echo cancellation engine 323 of echo watermarking and filtering mechanism 110 of FIG. 2 according to one embodiment. For brevity, clarity, and ease of understanding, many of the components and processes already described with reference to FIGS. 1-2 and 3A may not be described here. In the illustrated embodiment, computing device 100 (e.g., smartphone, etc.), in near-end acoustic environment 220, and computing device (e.g., tablet computer, etc.), in far-end acoustic environment 250, are shown to be in communication with each other via one or more communication applications (e.g., conventional telephone lines, Viber®, Skype®, Tango®, FaceTime®, etc.) over one or more networks, such as network 230.

For example, as user second user 351 speaks into speaking device 353 (e.g., microphone) at computing device 240, it generates communication signal 331 that is communicated over network 230 and received at computing device 100. In one embodiment, communication signal 331 is detected by WEC engine 321 where it is assigned a watermark as it leaves through listening device (e.g., loudspeaker) 213. Watermarked signal 333, upon departing computing device 100 via listening device 213, turns into watermarked echo 335 and enters back into computing device 100 via speaking device 215 (e.g., microphone). As illustrated, watermarked echo 335 may not be the only sound that may enter through speaking device 215 as it may be joined by other sounds, such as voice 337 of first user 331 speaking into speaking device 215, and other noise/sounds (e.g., traffic noise, chatter, background music, dog barking, etc.) within near-end acoustic environment 220.

These sounds 335, 337, 339 may enter computing device 100 as mixed signals 341 where, as aforementioned, watermarked echo is identified or detected by GWEC engine 323 and separated from mixed signals 341 for further processing. In one embodiment, the watermarked echo may be processed and filtered, at GWEC engine 323, to be completely or partially cancelled or, in another embodiment, it may not be filtered and allowed to proceed. In one embodiment, filtered or final signal 343 is then facilitated to be transmitted on to computing device 240 over network 230. At computing device 240, filtered signal 343 is broadcast to second user 351 through listening device (e.g., loudspeaker) 355.

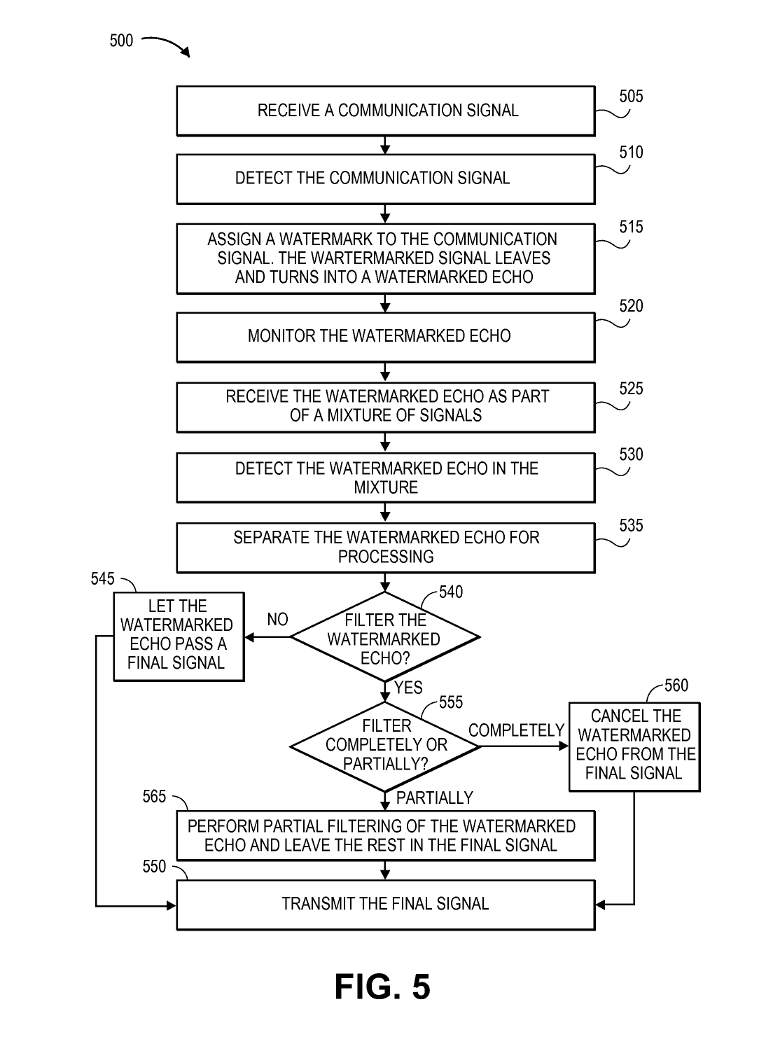

Referring to FIG. 5, it illustrates a method 500 for facilitating watermarking and filtering of echoes at a computing device according to one embodiment. Method 500 may be performed by processing logic that may comprise hardware (e.g., circuitry, dedicated logic, programmable logic, etc.), software (such as instructions run on a processing device), or a combination thereof. In one embodiment, method 500 may be performed by echo watermarking and filtering mechanism 110 FIG. 1. The processes of method 500 are illustrated in linear sequences for brevity and clarity in presentation; however, it is contemplated that any number of them can be performed in parallel, asynchronously, or in different orders. For brevity, clarity, and ease of understanding, many of the details discussed with reference to other Figures in this document are not discussed or repeated here.

Method 500 begins at block 505 with receiving of a communication signal at a first computing device (e.g., smartphone, tablet computer, etc.) from a second computing device (e.g., smartphone, tablet computer, etc.). At block 510, the communication signal's presence is detected within the first computing device. At block 515, in one embodiment, a watermark is assigned to the detected communication signal before it leaves the first computing device via loudspeaker (other any other listening device), wherein the watermarked signal is regarded or referred to as a watermarked echo once it departs the first computing device through its loudspeaker and gets into the air. In one embodiment, the signal may be sorted by or divided into any number of segments, where each segment refers to a frequency band. Accordingly, in one embodiment, any number of such segments (e.g., minority of segments, majority of segments, etc.) may be watermarked as opposed to watermarking the entire signal. In another embodiment, the entire signal may be watermarked or the entire signal may not be watermarked. For example, certain frequency bands may not be of concern if they are not audible to the human ear and thus they may not be watermarked for being not likely to translate into or act as an echo. At block 520, the watermarked echo is continuously monitored and subsequently, at block 525, it is received back at first computing device via its microphone (or any other speaking device).

It is contemplated that the watermarked echo may not be the only signal or sound entering the first computing device and that it may be mixed with other sounds, such as a first user's voice as s/he speaks into the microphone and other environmental sounds, such as traffic noise, background chatter, etc., that are found to be within a proximity of the first computing device. At block 530, in one embodiment, the watermarked echo is identified or detected out of the mix of sounds and signals. At block 535, the detected watermarked echo is separated from the mix to be further processed for filtering purposes.

At block 540, in one embodiment, a determination is made as to whether the watermarked echo is to be filtered. If the watermarked echo is not to be filtered, at block 545, the watermarked echo is allowed to pass as a final signal to the second computing device. For example, in some embodiments, the watermarked echo may not be filtered for any number of reasons, such as when preferred or desired by the user or when the watermarked echo may be used for specific purposes, such as security measures, police/detective or military purposes, science research, research and development or experimentation, etc. At block 550, the final signal (having the watermarked echo) is allowed to be transmitted to the second computing device.

Referring back to block 540, if the watermarked echo is to be filtered, the process continues with block 555 where another determination is made as to whether the watermarked echo is to be filtered completely or partially. If the entire watermarked echo is to be filtered, at block 560, the watermarked echo is completely filtered and cancelled/suppressed and subsequently, at block 550, the final signal (without having any of the watermarked echo) is transmitted on to the second computing device. Referring back to block 555, if the watermarked echo is to be partially filtered (e.g., certain segments or frequency bands are to be filtered out or cancelled/suppressed, while other segments are allowed to remain and pass), a final signal having partially filtered watermarked echo is facilitated to be transmitted on to the second computing device at block 550.

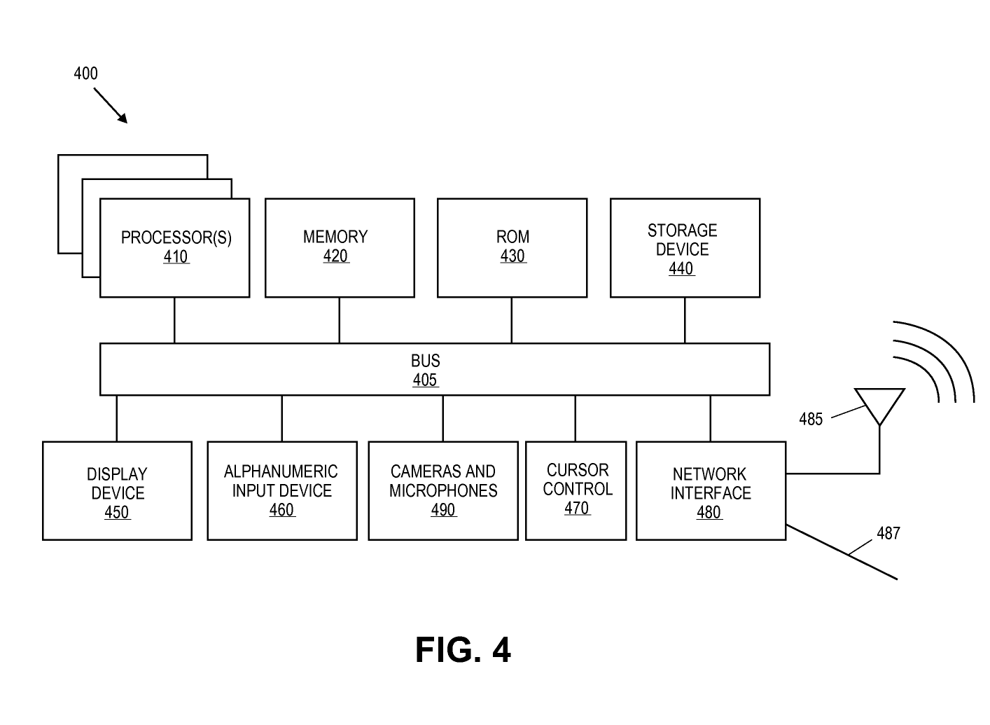

Now referring to FIG. 4, it illustrates an embodiment of a computing system 400. Computing system 400 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, etc. Alternate computing systems may include more, fewer and/or different components. Computing device 400 may be the same as or similar to or include computing devices 100, 240 of FIG. 2.

Computing system 400 includes bus 405 (or, for example, a link, an interconnect, or another type of communication device or interface to communicate information) and processor 410 coupled to bus 405 that may process information. While computing system 400 is illustrated with a single processor, electronic system 400 and may include multiple processors and/or co-processors, such as one or more of central processors, graphics processors, and physics processors, etc. Computing system 400 may further include random access memory (RAM) or other dynamic storage device 420 (referred to as main memory), coupled to bus 405 and may store information and instructions that may be executed by processor 410. Main memory 420 may also be used to store temporary variables or other intermediate information during execution of instructions by processor 410.

Computing system 400 may also include read only memory (ROM) and/or other storage device 430 coupled to bus 405 that may store static information and instructions for processor 410. Data storage device 440 may be coupled to bus 405 to store information and instructions. Data storage device 440, such as magnetic disk or optical disc and corresponding drive may be coupled to computing system 400.

Computing system 400 may also be coupled via bus 405 to display device 450, such as a cathode ray tube (CRT), liquid crystal display (LCD) or Organic Light Emitting Diode (OLED) array, to display information to a user. User input device 460, including alphanumeric and other keys, may be coupled to bus 405 to communicate information and command selections to processor 410. Another type of user input device 460 is cursor control 470, such as a mouse, a trackball, a touchscreen, a touchpad, or cursor direction keys to communicate direction information and command selections to processor 410 and to control cursor movement on display 450. Camera and microphone arrays 490 of computer system 400 may be coupled to bus 405 to observe gestures, record audio and video and to receive and transmit visual and audio commands.

Computing system 400 may further include network interface(s) 480 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 480 may include, for example, a wireless network interface having antenna 485, which may represent one or more antenna(e). Network interface(s) 480 may also include, for example, a wired network interface to communicate with remote devices via network cable 487, which may be, for example, an Ethernet cable, a coaxial cable, a fiber optic cable, a serial cable, or a parallel cable.

Network interface(s) 480 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 480 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 480 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 400 may vary from implementation to implementation depending upon numerous factors, such as price constraints, performance requirements, technological improvements, or other circumstances. Examples of the electronic device or computer system 400 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate echo watermarking and filtering, comprising: watermark assignment logic to assign a watermark to a communication signal, wherein the watermarked communication signal transforms into a watermarked echo upon exiting the apparatus; echo monitoring and reception logic to receive the watermarked echo; filtering and processing logic to filter the watermarked echo such that the watermarked echo is cancelled out of a final signal; and communication/compatibility logic to transmit the final signal that is free of the watermarked echo.

Example 2 includes the subject matter of Example 1, further comprising signal detection and evaluation logic to detect the communication signal, wherein the signal detection and evaluation logic is further to evaluate the detected communication signal as having a capacity to be transformed into the watermarked echo upon exiting the apparatus into the air, wherein the watermarked communication signal exits through a listening device including a loudspeaker.

Example 3 includes the subject matter of Example 1, wherein the echo monitoring and reception logic is further to continuously monitor the watermarked echo while the watermarked echo is in the air prior to its reception at the apparatus via a speaking device including a microphone.

Example 4 includes the subject matter of Example 1 or 3, further comprising watermark detection logic to detect the watermarked echo upon its reception via the speaking device, wherein the watermark detection logic is further to separate the detected watermarked echo from one or more sounds received via the speaking device.

Example 5 includes the subject matter of Example 4, wherein the one or more sounds comprises one or more of a first sound including a voice spoken into the speaking device by a user, and a second sound including noise being generated within a proximity of the speaking device, wherein the noise includes one or more of traffic noise, human chatter, music, and street noise.

Example 6 includes the subject matter of Example 1, wherein the watermark assignment logic is further to detection a plurality of segments relating to the communication signal, wherein each segment of the plurality of segments refers to a frequency brand, wherein the watermark assignment logic is further to assign the watermark to one or more of the plurality of segments.

Example 7 includes the subject matter of Example 6, wherein the communication signal is completely watermarked if each segment of the plurality of segments is assigned the watermark, wherein the communication signal is partially watermarked if one or more of the plurality of segments are assigned the watermarked, and wherein the communication signal is not watermarked if the plurality of segments is not assigned the watermark.

Example 8 includes the subject matter of Example 1 or 6, wherein filtering further comprises filtering out the plurality of segments to cancel out the watermarked echo from the final signal, wherein each of the plurality of segments is assigned the watermark.

Example 9 includes the subject matter of Example 1 or 6, wherein filtering further comprises filtering out one or more of the plurality of segments to partially cancel out the watermarked echo from the final signal, wherein the one or more of the plurality of segments include the watermarked one or more of the plurality of segments.

Example 10 includes the subject matter of Example 1 or 6, wherein filtering further comprises allowing the watermarked echo to remain within the final signal.

Some embodiments pertain to Example 11 that includes a method for facilitating echo watermarking and filtering, comprising: assigning a watermark to a communication signal, wherein the watermarked communication signal transforms into a watermarked echo upon exiting a computing device; receiving the watermarked echo; filtering the watermarked echo such that the watermarked echo is cancelled out of a final signal; and transmitting the final signal that is free of the watermarked echo.

Example 12 includes the subject matter of Example 11, further comprising: detecting the communication signal; and evaluating the detected communication signal as having a capacity to be transformed into the watermarked echo upon exiting the computing device into the air, wherein the watermarked communication signal exits through a listening device including a loudspeaker.

Example 13 includes the subject matter of Example 11, further comprising continuously monitoring the watermarked echo while the watermarked echo is in the air prior to its reception at the computing device via a speaking device including a microphone.

Example 14 includes the subject matter of Example 13, further comprising: detecting the watermarked echo upon its reception via the speaking device; and separating the detected watermarked echo from one or more sounds received via the speaking device.

Example 15 includes the subject matter of Example 14, wherein the one or more sounds comprises one or more of a first sound including a voice spoken into the speaking device by a user, and a second sound including noise being generated within a proximity of the speaking device, wherein the noise includes one or more of traffic noise, human chatter, music, and street noise.

Example 16 includes the subject matter of Example 11, further comprising detecting a plurality of segments relating to the communication signal, wherein each segment of the plurality of segments refers to a frequency brand, wherein watermark is assigned to one or more of the plurality of segments.

Example 17 includes the subject matter of Example 16, wherein the communication signal is completely watermarked if each segment of the plurality of segments is assigned the watermark, wherein the communication signal is partially watermarked if one or more of the plurality of segments are assigned the watermarked, and wherein the communication signal is not watermarked if the plurality of segments is not assigned the watermark.

Example 18 includes the subject matter of Example 11, wherein filtering further comprises filtering out the plurality of segments to cancel out the watermarked echo from the final signal, wherein each of the plurality of segments is assigned the watermark.

Example 19 includes the subject matter of Example 11, wherein filtering further comprises filtering out one or more of the plurality of segments to partially cancel out the watermarked echo from the final signal, wherein the one or more of the plurality of segments include the watermarked one or more of the plurality of segments.

Example 20 includes the subject matter of Example 11, wherein filtering further comprises allowing the watermarked echo to remain within the final signal.

Example 21 includes at least one machine-readable medium comprising a plurality of instructions that in response to being executed on a computing device, causes the computing device to carry out operations according to any one of the aforementioned examples 11 to 20.

Example 22 includes at least one non-transitory or tangible machine-readable medium comprising a plurality of instructions that in response to being executed on a computing device, causes the computing device to carry out operations according to any one of the aforementioned examples 11 to 20.

Example 23 includes a system comprising a mechanism to carry out operations according to any one of the aforementioned examples 11 to 20.

Example 24 includes an apparatus comprising means to carry out operations according to any one of the aforementioned examples 11 to 20.

Example 25 includes a computing device arranged to carry out operations according to any one of the aforementioned examples 11 to 20.

Example 26 includes a communications device arranged to carry out operations according to any one of the aforementioned examples 11 to 20.

Some embodiments pertain to Example 27 includes a system comprising a storage device having instructions, and a processor to execute the instructions to facilitate a mechanism to perform one or more operations comprising: assigning a watermark to a communication signal, wherein the watermarked communication signal transforms into a watermarked echo upon exiting a computing device; receiving the watermarked echo; filtering the watermarked echo such that the watermarked echo is cancelled out of a final signal; and transmitting the final signal that is free of the watermarked echo.

Example 28 includes the subject matter of Example 27, wherein the one or more operations comprise detecting the communication signal; and evaluating the detected communication signal as having a capacity to be transformed into the watermarked echo upon exiting the computing device into the air, wherein the watermarked communication signal exits through a listening device including a loudspeaker.

Example 29 includes the subject matter of Example 27, wherein the one or more operations comprise continuously monitoring the watermarked echo while the watermarked echo is in the air prior to its reception at the computing device via a speaking device including a microphone.

Example 30 includes the subject matter of Example 29, wherein the one or more operations comprise detecting the watermarked echo upon its reception via the speaking device; and separating the detected watermarked echo from one or more sounds received via the speaking device.

Example 31 includes the subject matter of Example 30, wherein the one or more sounds comprises one or more of a first sound including a voice spoken into the speaking device by a user, and a second sound including noise being generated within a proximity of the speaking device, wherein the noise includes one or more of traffic noise, human chatter, music, and street noise.

Example 32 includes the subject matter of Example 27, wherein the one or more operations comprise detecting a plurality of segments relating to the communication signal, wherein each segment of the plurality of segments refers to a frequency brand, wherein watermark is assigned to one or more of the plurality of segments.

Example 33 includes the subject matter of Example 32, wherein the communication signal is completely watermarked if each segment of the plurality of segments is assigned the watermark, wherein the communication signal is partially watermarked if one or more of the plurality of segments are assigned the watermarked, and wherein the communication signal is not watermarked if the plurality of segments is not assigned the watermark.

Example 34 includes the subject matter of Example 27, wherein filtering further comprises filtering out the plurality of segments to cancel out the watermarked echo from the final signal, wherein each of the plurality of segments is assigned the watermark.

Example 35 includes the subject matter of Example 27, wherein filtering further comprises filtering out one or more of the plurality of segments to partially cancel out the watermarked echo from the final signal, wherein the one or more of the plurality of segments include the watermarked one or more of the plurality of segments.

Example 36 includes the subject matter of Example 27, wherein filtering further comprises allowing the watermarked echo to remain within the final signal.

Some embodiments pertain to Example 37 includes an apparatus comprising: means for assigning a watermark to a communication signal, wherein the watermarked communication signal transforms into a watermarked echo upon exiting a computing device; means for receiving the watermarked echo; means for filtering the watermarked echo such that the watermarked echo is cancelled out of a final signal; and means for transmitting the final signal that is free of the watermarked echo.

Example 38 includes the subject matter of Example 37, further comprising: means for detecting the communication signal; and means for evaluating the detected communication signal as having a capacity to be transformed into the watermarked echo upon exiting the computing device into the air, wherein the watermarked communication signal exits through a listening device including a loudspeaker.

Example 39 includes the subject matter of Example 37, further comprising continuously monitoring the watermarked echo while the watermarked echo is in the air prior to its reception at the computing device via a speaking device including a microphone.

Example 40 includes the subject matter of Example 39, further comprising means for detecting the watermarked echo upon its reception via the speaking device; and means for separating the detected watermarked echo from one or more sounds received via the speaking device.

Example 41 includes the subject matter of Example 40, wherein the one or more sounds comprises one or more of a first sound including a voice spoken into the speaking device by a user, and a second sound including noise being generated within a proximity of the speaking device, wherein the noise includes one or more of traffic noise, human chatter, music, and street noise.

Example 42 includes the subject matter of Example 37, further comprising means for detecting a plurality of segments relating to the communication signal, wherein each segment of the plurality of segments refers to a frequency brand, wherein watermark is assigned to one or more of the plurality of segments.

Example 43 includes the subject matter of Example 32, wherein the communication signal is completely watermarked if each segment of the plurality of segments is assigned the watermark, wherein the communication signal is partially watermarked if one or more of the plurality of segments are assigned the watermarked, and wherein the communication signal is not watermarked if the plurality of segments is not assigned the watermark.

Example 44 includes the subject matter of Example 37, wherein the means for filtering further comprises means for filtering out the plurality of segments to cancel out the watermarked echo from the final signal, wherein each of the plurality of segments is assigned the watermark.

Example 45 includes the subject matter of Example 37, wherein the means for filtering further comprises means for filtering out one or more of the plurality of segments to partially cancel out the watermarked echo from the final signal, wherein the one or more of the plurality of segments include the watermarked one or more of the plurality of segments.

Example 46 includes the subject matter of Example 37, wherein the means for filtering further comprises means for allowing the watermarked echo to remain within the final signal.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1.-25. (canceled)

26. An apparatus comprising:
watermark assignment logic to assign a watermark to a communication signal, wherein the watermarked communication signal transforms into a watermarked echo upon exiting the apparatus;
echo monitoring and reception logic to receive the watermarked echo;
filtering and processing logic to filter the watermarked echo such that the watermarked echo is cancelled out of a final signal; and
communication/compatibility logic to transmit the final signal that is free of the watermarked echo.

27. The apparatus of claim 26, further comprising signal detection and evaluation logic to detect the communication signal, wherein the signal detection and evaluation logic is further to evaluate the detected communication signal as having a capacity to be transformed into the watermarked echo upon exiting the apparatus into the air, wherein the watermarked communication signal exits through a listening device including a loudspeaker.

28. The apparatus of claim 26, wherein the echo monitoring and reception logic is further to continuously monitor the watermarked echo while the watermarked echo is in the air prior to its reception at the apparatus via a speaking device including a microphone.

29. The apparatus of claim 26, further comprising watermark detection logic to detect the watermarked echo upon its reception via the speaking device, wherein the watermark detection logic is further to separate the detected watermarked echo from one or more sounds received via the speaking device.

30. The apparatus of claim 29, wherein the one or more sounds comprises one or more of a first sound including a voice spoken into the speaking device by a user, and a second sound including noise being generated within a proximity of the speaking device, wherein the noise includes one or more of traffic noise, human chatter, music, and street noise.

31. The apparatus of claim 26, wherein the watermark assignment logic is further to detection a plurality of segments relating to the communication signal, wherein each segment of the plurality of segments refers to a frequency brand, wherein the watermark assignment logic is further to assign the watermark to one or more of the plurality of segments.

32. The apparatus of claim 31, wherein the communication signal is completely watermarked if each segment of the plurality of segments is assigned the watermark, wherein the communication signal is partially watermarked if one or more of the plurality of segments are assigned the watermarked, and wherein the communication signal is not watermarked if the plurality of segments is not assigned the watermark.

33. The apparatus of claim 26, wherein filtering further comprises filtering out the plurality of segments to cancel out the watermarked echo from the final signal, wherein each of the plurality of segments is assigned the watermark.

34. The apparatus of claim 26, wherein filtering further comprises filtering out one or more of the plurality of segments to partially cancel out the watermarked echo from the final signal, wherein the one or more of the plurality of segments include the watermarked one or more of the plurality of segments.

35. The apparatus of claim 26, wherein filtering further comprises allowing the watermarked echo to remain within the final signal.

36. A method comprising:
assigning a watermark to a communication signal, wherein the watermarked communication signal transforms into a watermarked echo upon exiting a computing device;
receiving the watermarked echo;
filtering the watermarked echo such that the watermarked echo is cancelled out of a final signal; and
transmitting the final signal that is free of the watermarked echo.

37. The method of claim 36, further comprising:
detecting the communication signal; and
evaluating the detected communication signal as having a capacity to be transformed into the watermarked echo upon exiting the computing device into the air, wherein the watermarked communication signal exits through a listening device including a loudspeaker.

38. The method of claim 36, further comprising continuously monitoring the watermarked echo while the watermarked echo is in the air prior to its reception at the computing device via a speaking device including a microphone.

39. The method of claim 36, further comprising:
detecting the watermarked echo upon its reception via the speaking device; and
separating the detected watermarked echo from one or more sounds received via the speaking device.

40. The method of claim 39, wherein the one or more sounds comprises one or more of a first sound including a voice spoken into the speaking device by a user, and a second sound including noise being generated within a proximity of the speaking device, wherein the noise includes one or more of traffic noise, human chatter, music, and street noise.

41. The method of claim 36, further comprising detecting a plurality of segments relating to the communication signal, wherein each segment of the plurality of segments refers to a frequency brand, wherein watermark is assigned to one or more of the plurality of segments.

42. The method of claim 41, wherein the communication signal is completely watermarked if each segment of the plurality of segments is assigned the watermark, wherein the communication signal is partially watermarked if one or more of the plurality of segments are assigned the watermarked, and wherein the communication signal is not watermarked if the plurality of segments is not assigned the watermark.

43. The method of claim 36, wherein filtering further comprises filtering out the plurality of segments to cancel out the watermarked echo from the final signal, wherein each of the plurality of segments is assigned the watermark.

44. The method of claim 36, wherein filtering further comprises filtering out one or more of the plurality of segments to partially cancel out the watermarked echo from the final signal, wherein the one or more of the plurality of segments include the watermarked one or more of the plurality of segments.

45. The method of claim 36, wherein filtering further comprises allowing the watermarked echo to remain within the final signal.

46. At least one machine-readable medium comprising a plurality of instructions that in response to being executed on a computing device, causes the computing device to carry out one or more operations comprising:
assigning a watermark to a communication signal, wherein the watermarked communication signal transforms into a watermarked echo upon exiting a computing device;
receiving the watermarked echo;
filtering the watermarked echo such that the watermarked echo is cancelled out of a final signal; and
transmitting the final signal that is free of the watermarked echo.

47. The machine-readable medium of claim 46, wherein the one or more operations further comprise:
detecting the communication signal; and
evaluating the detected communication signal as having a capacity to be transformed into the watermarked echo upon exiting the computing device into the air, wherein the watermarked communication signal exits through a listening device including a loudspeaker.

48. The machine-readable medium of claim 46, further comprising:
continuously monitoring the watermarked echo while the watermarked echo is in the air prior to its reception at the computing device via a speaking device including a microphone;
detecting the watermarked echo upon its reception via the speaking device; and
separating the detected watermarked echo from one or more sounds received via the speaking device,
wherein the one or more sounds comprises one or more of a first sound including a voice spoken into the speaking device by a user, and a second sound including noise being generated within a proximity of the speaking device, wherein the noise includes one or more of traffic noise, human chatter, music, and street noise.

49. The machine-readable medium of claim 46, further comprising detecting a plurality of segments relating to the communication signal, wherein each segment of the plurality of segments refers to a frequency brand, wherein watermark is assigned to one or more of the plurality of segments,
wherein the communication signal is completely watermarked if each segment of the plurality of segments is assigned the watermark, wherein the communication signal is partially watermarked if one or more of the plurality of segments are assigned the watermarked, and wherein the communication signal is not watermarked if the plurality of segments is not assigned the watermark

50. The machine-readable medium of claim 46, wherein filtering further comprises filtering out the plurality of segments to cancel out the watermarked echo from the final signal, wherein each of the plurality of segments is assigned the watermark,
wherein filtering further comprises filtering out one or more of the plurality of segments to partially cancel out the watermarked echo from the final signal, wherein the one or more of the plurality of segments include the watermarked one or more of the plurality of segments, and
wherein filtering further comprises allowing the watermarked echo to remain within the final signal.
